(19) United States
(12) Patent Application Publication
(10) Pub. No.: US 2018/0357530 A1
(43) Pub. Date: Dec. 13, 2018

(54) DEEP LEARNING DECODING OF ERROR CORRECTING CODES

(71) Applicant: Ramot at Tel-Aviv University Ltd., Tel-Aviv (IL)

(72) Inventors: Yair BEERY, Tel-Aviv (IL); David Burshtein, Tel-Aviv (IL); Eliya Nachmani, Tel-Aviv (IL)

(21) Appl. No.: 15/996,542

(22) Filed: Jun. 4, 2018

Related U.S. Application Data
(60) Provisional application No. 62/518,642, filed on Jun. 13, 2017.

(51) Int. Cl. G06N 3/04; G06N 3/08

(52) U.S. Cl. CPC G06N 3/0445; G06N 3/084

(57) ABSTRACT

A method of decoding a linear block code transmitted over a transmission channel subject to noise, comprising receiving, over a transmission channel, a linear block code corresponding to a parity check matrix, propagating the received code through a neural network of one or more decoders, the neural network having an input layer, an output layer and a plurality of hidden layers comprising a plurality of nodes corresponding to transmitted messages over a plurality of edges of a bipartite graph representation of the encoded code and a plurality of edges connecting the plurality of nodes, each edge having source node and destination nodes is assigned with a weight calculated during a training session of the neural network, the propagation follows a propagation path through the neural network dictated by respective weights of the edges and outputting a recovered version of the code according to a final output of the neural network.

### RELATED APPLICATIONS

This application claims the benefit of priority under 35 USC 119(e) of U.S. Provisional Patent Application No. 62/518,642 filed on Jun. 13, 2017, the contents of which are incorporated herein by reference in their entirety.

### BACKGROUND

The present invention, in some embodiments thereof, relates to decoding an encoded linear block code transmitted over a transmission channel, and, more specifically, but not exclusively, to decoding an encoded linear block code transmitted over a transmission channel using trained neural networks.

Transmission of data over transmission channels, either wired and/or wireless is an essential building block for most modern era data technology applications. However, such transmission channels are typically subject to interferences such as, noise, crosstalk, attenuation, etc. which may degrade the transmission channel performance for carrying the communication data and may lead to loss of data at the receiving side. One of the methods to overcome this is to encode the data with error correcting data which may allow the receiving side to detect and/or correct errors in the received encoded data. Such methods may utilize one or more error correcting models as known in the art, for example, algebraic linear code, polar code and Low Density Parity Check (LDPC), High Density Parity Check (HDPC) codes among others.

In recent years deep learning methods have demonstrated significant improvements in various applications and tasks. The deep learning methods have been proved to outperform human-level object detection in some applications and achieve state-of-the-art results in other applications, for example, computer vision, machine translation, speech processing, bio-informatics, etc. Additionally, deep learning combined with reinforcement learning techniques was able to beat human champions in challenging games such as Go chess and more. The rapid evolution and outstanding results of deep learning models may be driven by the ever more powerful computing resources achieved by, for example, Graphical Processing Units (GPU), parallel computing, multi-threading architectures, etc. Moreover, the deep learning models are enhanced through efficient utilization of large collections of datasets currently available and constantly increasing. In addition, advanced academic research on training methods and network architectures constantly contributes to the improvement of the deep learning models.

### SUMMARY

According to a first aspect of the present invention there is provided a computer implemented method of decoding a linear block code transmitted over a transmission channel subject to noise, comprising using one or more processors for:
Receiving, over a transmission channel, a linear block code corresponding to a parity check matrix.
Propagating the received code through a neural network of one or more decoders. The neural network having an input layer, an output layer and a plurality of hidden layers comprising a plurality of nodes corresponding to transmitted messages over a plurality of edges of a bipartite graph representation of the encoded code and a plurality of edges connecting the plurality of nodes. Each one of the plurality of edges having a source node and a destination node is assigned with a weight previously calculated during a training session of the neural network. The propagation follows a propagation path through the neural network dictated by respective weights of the plurality of edges.
Outputting a recovered version of the code according to a final output of the neural network.

According to a second aspect of the present invention there is provided a system for decoding a linear block code transmitted over a transmission channel subject to noise, comprising one or more processors adapted to execute code, the code comprising:
Code instructions to receive, over a transmission channel, a linear block code corresponding to a parity check matrix.
Code instructions to propagate the received code through a neural network of one or more decoders. The neural network having an input layer, an output layer and a plurality of hidden layers comprising a plurality of nodes corresponding to transmitted messages over a plurality of edges of a bipartite graph representation of the encoded code and a plurality of edges connecting the plurality of nodes. Each one of the plurality of edges having a source node and a destination node is assigned with a weight previously calculated during a training session of the neural network. The propagation follows a propagation path through the neural network dictated by respective weights of the plurality of edges.
Code instructions to output a recovered version of the code according to a final output of the neural network.

The trained neural network decoder may replace standard decoder in most if not all linear block code decoding applications. The neural network decoder performance may be significantly increased compared to the standard decoder while requiring significantly less computing resources. Properly weighting the messages during the training session may allow compensating for small cycles in the bipartite graph and may result in reduced latency for the decoding process using the neural network decoder compared to the standard decoder. Moreover, the Bit Error Rate (BER) performance of the neural network decoder may be significantly improved. Furthermore, during training, the neural network decoder learns characteristics of both the channel and the linear code simultaneously.

In a further implementation form of the first and/or second aspects, the bipartite graph is a member of a group consisting of: a Tanner graph and a factor graph. Supporting and/or applying a plurality of graph representations of the encoded linear block code may allow selection and/or adaptation of the graph according to the specific characteristics of the application using the neural network decoder.

In a further implementation form of the first and/or second aspects, the parity check matrix is a member of a group consisting of: algebraic linear code, polar code, Low Density Parity Check (LDPC) code and High Density Parity Check (HDPC) code. The neural network decoder supports a wide range of linear block codes corresponding to most parity matrices known in the art thus allowing the neural network decoder to replace standard decoders used by a plurality of applications.

In a further implementation form of the first and/or second aspects, the training session is conducted through a plurality of training iterations using a dataset comprising a plurality of samples. Each of the plurality of samples maps one or more training codewords of the code that is subjected to a different noise pattern injected to the transmission channel. Training the neural network decoder with a plurality of codeword samples may allow adaptation of the neural network decoder to a plurality of noise effects thus significantly improving the neural network decoder performance, for example, lower latency, lower BER and/or the like.

In a further implementation form of the first and/or second aspects, one or more training codewords is the zero codeword. Training the neural network decoder with the zero codewords which are part of the linear block code may require significantly reduced computing resources for the training session compared to non-zero codewords while the neural network decoder trained with the zero codewords presents similar performance (e.g. latency, BER) as a neural network decoder trained with the non-zero codewords.

In a further implementation form of the first and/or second aspects, the training is done using one or more of: stochastic gradient descent, batch gradient descent and mini-batch gradient descent. Using training techniques as known in the art may significantly reduce the development, adaptation and/or integration effort for training the neural network decoder.

In a further implementation form of the first and/or second aspects, during the training, an updated marginalization value is calculated for each even layer of the plurality of hidden layers, a multi-loss function used for the training is updated with the updated marginalization value. The neural network architecture has the property that after every even hidden layer a final marginalization value may be updated. This property may be used to add additional terms in the loss function thus increasing the gradient update at the backpropagation algorithm and allowing learning the lower layers.

In a further implementation form of the first and/or second aspects, the neural network is a feed-forward neural network in which the weight is arbitrarily set for each of a plurality of corresponding edges in each layer of the neural network. The feed-forward (FF) neural network decoder is a simple neural network implementation requiring a significantly low effort and/or low complexity training session.

In a further implementation form of the first and/or second aspects, the neural network is a recurrent neural network (RNN) in which the weight is equal for corresponding edges in each layer of the neural network. The RNN decoder may present improved performance compared to the FF neural network decoder while having less free weights.

In an optional implementation form of the first and/or second aspects, the weight is quantized. Quantizing the weights may significantly reduce memory size and accesses, and may optionally allow replacing most arithmetic operations with bit-wise operations.

In an optional implementation form of the first and/or second aspects, an aggregated recovered version of the code is generated by aggregating the recovered version produced by a plurality of decoders such as the one or more decoders. Using a plurality of decoders (decoding branches) simultaneously decoding the linear block code may significantly reduce latency and/or improve BER performance since deviations in individual decoder branches may be compensated for.

In a further implementation form of the first and/or second aspects, the weight is calculated for each one of the plurality of decoders by training a respective neural network of the each decoder using a different set of permutation values of the code following each of a plurality of training iterations. Wherein the set of permutation values is deterministically set and/or randomly selected from an automorphism group of the code. Using various permutations for the plurality of decoder branches may significantly improve the performance of the neural network decoder(s) since the aggregated version is created from a plurality of decoder results applying a variety of permutation values thus adapted for a plurality of decoding scenarios and noise patterns and/or effects.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of decoding an encoded linear block code transmitted over a transmission channel using a trained neural network, according to some embodiments of the present invention;

FIG. 2 is a schematic illustration of an exemplary decoding system utilizing a trained neural network for decoding an encoded linear block code transmitted over a transmission channel, according to some embodiments of the present invention;

FIG. 3 is a schematic illustration of an exemplary Feed-Forward (FF) deep neural network used for decoding an encoded linear block code, according to some embodiments of the present invention;

FIG. 4 is a schematic illustration of an exemplary modified Random Redundant Iterative Decoding (mRRD) decoder with m parallel decoders used for decoding an encoded linear block code, according to some embodiments of the present invention;

FIG. 5 is a schematic illustration of an exemplary Feed-Forward (FF) deep neural network decoders applying multi-loss for decoding an encoded linear block code, according to some embodiments of the present invention;

FIG. 6A, FIG. 6B and FIG. 6C are graph charts of Bit Error Rate (BER) results for a neural network decoder decoding BCH(63,36), BCH(63,45) and BCH(127, 106) encoded linear block codes respectively, according to some embodiments of the present invention;

FIG. 7 is a graph chart of BER results for a neural network decoder applying multi-loss for decoding a BCH(63,45) encoded linear block code, according to some embodiments of the present invention;

FIG. 8 is a histogram chart of a distribution of weights assigned to a an output layer of a neural network decoder used for decoding a BCH(63,45) encoded linear block code, according to some embodiments of the present invention;

FIG. 9 and FIG. 10 are plots of weights assigned to a last hidden layer of a Belief Propagation (BP) decoder and a neural network decoder respectively used for decoding a BCH(63,45) encoded linear block code, according to some embodiments of the present invention;

FIG. 11 is a schematic illustration of an exemplary Recurrent Neural Network (RNN) utilized by a decoder for decoding an encoded linear block code, according to some embodiments of the present invention;

FIG. 12A and FIG. 12B are graph charts of BER results for neural network decoders applying regular parity check for decoding BCH(63,45) and BCH(63,36) encoded linear block codes respectively, according to some embodiments of the present invention;

FIG. 13A and FIG. 13B are graph charts of BER results for neural network decoders applying reduced parity check for decoding BCH(63,45) and BCH(63,36) encoded linear block codes respectively, according to some embodiments of the present invention;

FIG. 14 is a graph chart of BER results for a neural network decoder applying regular parity check for decoding a BCH(127,64) encoded linear block code, according to some embodiments of the present invention;

FIG. 15A and FIG. 15B are graph chart of BER results for a neural network decoders applying reduced parity check for decoding BCH(127,64) and BCH(127,99) encoded linear block codes respectively, according to some embodiments of the present invention;

FIG. 16 is a graph chart of BER results for mRRD and mRRD-RNN decoders decoding a BCH(63,36) encoded linear block code, according to some embodiments of the present invention; and

FIG. 17 is a graph chart of average number of BP iterations for mRRD and mRRD-RNN decoders decoding a BCH(63,36) encoded linear block code, according to some embodiments of the present invention.

### DETAILED DESCRIPTION

The present invention, in some embodiments thereof, relates to decoding an encoded linear block code transmitted over a transmission channel, and, more specifically, but not exclusively, to decoding an encoded linear block code transmitted over a transmission channel using trained neural networks.

A major motivation for utilizing efficient error correction codes and effective decoders is the increasing need to accurately recover transmitted encoded codes while maintaining high transmission rates. Since the transmission channel may be subject to interferences such as, noise, crosstalk, attenuation, etc., errors may be induced in the transmitted encoded code. Using the error correction codes to detect and/or correct errors in the code may allow efficient recovery of the transmitted code.

The encoded codes may typically include linear block codes encoded using one or more error correction coding schemes such as, for example, algebraic linear code, polar code, Low Density Parity Check (LDPC) code, High Density Parity Check (HDPC) code and/or the like.

One of the current state of the art decoding algorithms for decoding the encoded linear block code is the Belief Propagation (BP) algorithm which may achieve high transmission rates close to the Shannon channel capacity when decoding LDPC codes, in particular for relatively large block lengths of the code. However for HDPC codes, such as common powerful linear block algebraic codes, the BP algorithm obtains poor results compared to an optimal decoder. The use of such short to moderate linear block codes which may require low complexity, low latency and/or low power decoders is rapidly increasing with the emergence of plurality of low end applications, for example, the Internet of Things.

According to some embodiments of the present invention, there are provided methods and systems for constructing and/or formalizing the BP algorithm using one or more neural networks for decoding encoded linear block codes corresponding to one or more of the parity check matrices, i.e. the algebraic linear code, the polar code, the LDPC code, the HDPC code and/or the like. As demonstrated herein after, using the neural network, the BP algorithm may be significantly improved to produce improved decoding results while increasing the transmission bandwidth and/or reducing computation resources.

The neural network comprises an input layer, an output layer and a plurality of hidden layers and is constructed from a plurality of nodes connected with a plurality of edges. The nodes correspond to transmitted messages over a plurality of edges of a bipartite graph (or bigraph) (e.g. a Tanner graph, a factor graph, etc.) representation of the encoded code and each of the edges connects a source node to a destination node.

The naive approach is to assume a neural network type decoder without restrictions, and train the weights of the neural network using a dataset that contains a large amount of codewords. The training goal is to reconstruct the transmitted codeword from a noisy version after transmitted over the transmission channel. Unfortunately, using this approach, the neural network decoder is not given any side information regarding the structure of the linear code. In fact the decoder may not be even aware of the fact that the code is linear. Hence the decoder may need to be trained using a huge collection (samples dataset) of codewords from the code, and due to the exponential nature of the problem, this may be infeasible and/or impractical. For example, for a BCH(63,45) code, a dataset of 2⁴⁵ codewords may be required for training the neural network. On top of that, the dataset of samples used for training the neural network needs to reflect the variability due to the noisy transmission channel.

In order to overcome this issue, the neural network may be adjusted to assign weights to the edges of the bipartite graph representing the encoded linear code, thus yielding a “soft” bipartite graph that may replace the original bipartite graph of the encoded code. These weights may be calculated and/or determined during training of the neural network using deep learning techniques.

A well-known property of the BP algorithm is the independence of the performance from the transmitted codeword. This means that the performance of the BP decoder is independent (indifferent) to the transmitted codeword such that the performance may remain similar for any transmitted codeword. This property of the BP algorithm is preserved by the neural network decoder. It is therefore sufficient to use a single codeword for training the weights (parameters) of the neural network decoder. In particular, the zero codeword (all zero) may be sufficient for training the neural network as the architecture guarantees the same error rate for any chosen transmitted codeword. As demonstrated herein after the neural network decoder implementation present significant improvement over the BP decoder for various HDPC codes, such as, for example, BCH(63,36), BCH(63,45) and BCH(127,106).

According to some embodiments of the present invention, the neural network decoder utilizes a feed-forward (FF) neural network employing a sum-product algorithm in which the weights assigned to the edges of the neural network are selected arbitrarily. The FF neural network decoder may present improved performance, for example, lower latency, lower utilization of computing resources, improved Signal-to-Noise Ratio (SNR) and/or the like compared to the BP based decoders.

According to some embodiments of the present invention, the neural network decoder utilizes a Recurrent Neural Network (RNN) in which the weights of the edges of the RNN are tied between layers, i.e. corresponding edges in the layers of the RNN as assigned with equal weights. The performance of the RNN based decoder may be similar to that of the FF neural network decoder implementation while reducing the number of free weights of the neural network thus reducing complexity, implementation cost and/or the like. Moreover, even when used with lower densities parity check matrices and/or with fewer short cycles, the RNN decoder presents improved decoding performance, reduced latency and/or reduced utilization of computing resources compared to the BP based decoder as well as compared to the FF neural network based decoder.

Optionally, the weights assigned to the edges of the neural network decoder are quantized using one or more techniques as known in the art for quantizing the weights of a neural network.

In practice the trained deep neural network based decoders (i.e. the FF neural network decoder and the RNN decoder) may replace the BP decoder in most if not all applications currently utilizing the BP algorithm, in particular in applications involving short to moderate algebraic linear codes. Thus, it may be only natural to replace the standard BP decoder with the trained FF neural network decoder and/or the RNN decoder. In one exemplary embodiment, the neural network decoder may replace the BP decoder utilized in a Modified Redundant Iterative Decoding (mRRD) employing a plurality of decoders and aggregating the output of all decoders to produce a recovered version of the transmitted encoded code.

As presented herein after and demonstrated by experiments conducted to evaluate and validate the neural network based decoders, the neural network decoder performance may be significantly increased compared to the BP decoder which may require significant computing resources and/or present considerable latency for conducting repeated multiplications and hyperbolic functions to compute the check node function. This is primarily achieved through the use of the “soft” bipartite graph in which the edges are assigned with weights compared to the standard bipartite graph having binary edges as used by the BP decoder. The improved performance which may be expressed through the BER may be achieved by properly weighting the messages, such that the effect of small cycles in the bipartite graph may be partially compensated.

Moreover, the parity check matrices the neural network decoder applies are standard parity check matrices as known in the art, thus no alteration, manipulation and/or adjustment may be required to the code and/or to the encoder. Therefore standard encoders as used in the art may be used in conjunction with the novel neural network decoders.

Furthermore, during training, the neural network decoder learns characteristics of both the channel and the linear code simultaneously.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer Program code comprising computer readable program instructions embodied on a computer readable medium may be transmitted using any appropriate medium, including but not limited to wireless, wire line, optical fiber cable, RF, etc., or any suitable combination of the foregoing.

The program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code can be downloaded to respective computing/processing devices from a computer readable storage medium or to an external computer or external storage device via a network, for example, the Internet, a local area network, a wide area network and/or a wireless network.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

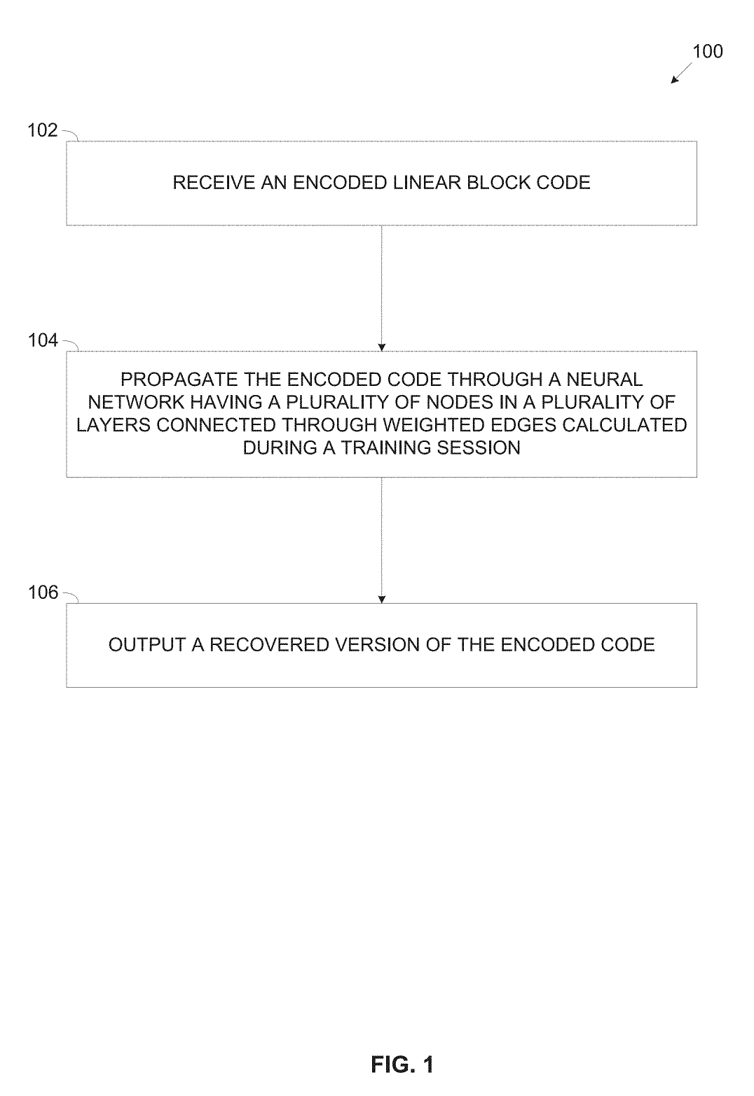

Referring now to the drawings, FIG. 1 illustrates a flowchart of an exemplary process of decoding an encoded linear block code transmitted over a transmission channel using a trained neural network, according to some embodiments of the present invention. An exemplary process 100 may be executed by a decoder utilizing a neural network, for example, a deep neural network for decoding one or more encoded linear block code encoded using one or more error correction coding schemes.

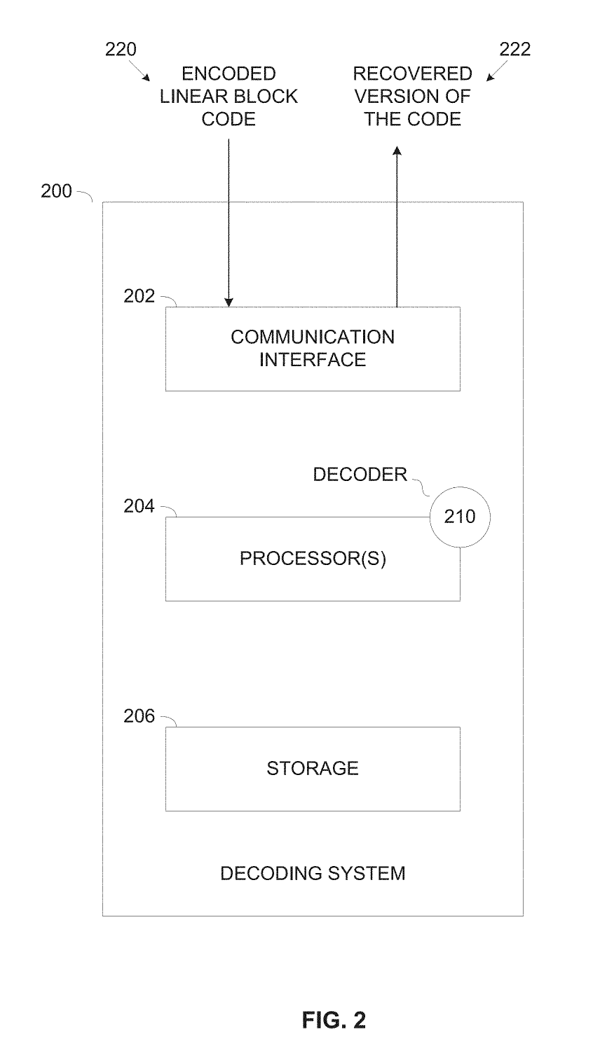

Reference is also made to FIG. 2, which is a schematic illustration of an exemplary decoding system utilizing a trained neural network for decoding an encoded linear block code transmitted over a transmission channel, according to some embodiments of the present invention. An exemplary decoding system (decoder) 200 may comprise a communication interface 202, a processor(s) 204 for executing a process such as the process 100 and a storage 206 for storing code and/or data.

The communication interface 202 may connect to one or more wired and/or wireless communication (transmission) channels, for example, a Local Area Network (LAN), a Wide Area Network (WAN), a Municipal Area Network (MAN), a cellular network, a Radio Frequency (RF) network, a Wireless LAN (WLAN) and/or the like established over one or more wired and/or wireless transmission lines and/or mediums.

The processor(s) 204, homogenous or heterogeneous, may include one or more processing nodes arranged for parallel processing, as clusters and/or as one or more multi core processor(s). The storage 206 may include one or more non-transitory memory devices, either persistent non-volatile devices, for example, a hard drive, a solid state drive (SSD), a magnetic disk, a Flash array and/or the like and/or volatile devices, for example, a Random Access Memory (RAM) device, a cache memory and/or the like.

The processor(s) 204 may execute one or more software modules, for example, a process, a script, an application, an agent, a utility, a tool and/or the like each comprising a plurality of program instructions stored in a non-transitory medium such as the storage 206 and executed by one or more processors such as the processor(s) 204. For example, the processor(s) 204 may execute a decoder 210 for decoding one or more encoded linear block codes such as the encoded linear block code 220.

Additionally and/or alternatively, the decoder 210 may be utilized by one or more specifically adapted hardware components, for example, a Field Programmable Gate array (FPGA), an Application Specific Integrated Circuit(ASIC) and/or the like adapted to execute the process 100 and/or part thereof. Optionally, the decoder 210 is implemented by a combination of the processor(s) 204 executing one or more software modules and one or more of the specifically adapted hardware components.

The decoder 210 may receive, via the communication interface 202, one or more encoded linear block codes 220 encoded using one or more error correction coding schemes such as, for example, algebraic linear code, polar code, Low Density Parity Check (LDPC) code, High Density Parity Check (HDPC) code and/or the like transmitted over the transmission channel(s). Similarly, via the communication interface 202, the decoder 210 may transmit a recovered version 222 of the encoded linear block codes 220 to one or more remote locations, for example, a server, a storage server, a cloud service and/or the like. Additionally and/or alternatively, the decoder 210 may store the recovered version 222 in the storage 206.

As shown at 102, the process 100 starts with the decoder 210 receiving an encoded linear block code 220, for example, from the communication interface 202.

As shown at 104, the decoder 210 propagates the encoded linear block code 220 through a trained neural network.

As shown at 106, the decoder 210 outputs a recovered version of the encoded linear block code 220. The decoder 210 may obtain the recovered version according to a final output of the trained neural network.

Before describing at least one embodiment of the present invention, some background is provided for the BP algorithm which may be used for decoding linear block codes as known in the art. The BP decoder is a messages passing algorithm which may be constructed from a Tanner graph which is a graphical representation of a parity check matrix that describes the encoded code. The Tanner graph graphical representation consists of a plurality of nodes connected with edges. There are two types of nodes, check nodes (denoted c herein after) corresponding to rows in the parity check matrix and variable nodes (denoted v herein after) corresponding to columns in the parity check matrix. The edges correspond to ones in the parity check matrix. In message passing based decoders such as the BP algorithm based decoders, the messages are transmitted over the edges. Each edge calculates its outgoing message based on all incoming messages the respective edge receives over all its edges, except for the message received on the transmitting edge of the respective edge.

First, an alternative graphical representation may be created for the BP algorithm based decoder in which L full decoding iterations are conducted using, for example, parallel (flooding) scheduling. The alternative representation is a trellis in which the nodes in the hidden layers correspond to edges in the Tanner graph. Assuming a linear code with block length (i.e., the number of variable nodes in the Tanner graph) N, the input to the BP decoder may be vector of size N. The input layer of the trellis representation of the BP decoder may therefore consist of N nodes comprising Log-Likelihood Ratios (LLR) of the channel outputs which represent “noisy” versions of the codebits of the encoded code block received by the decoder. The LLR value lᵥ of a variable node v of the input layer, where v=1, 2, . . . , N, is given by the following equation:

$${l}_{v} = log \frac{Pr ( {C}_{v} = 1 \vert {y}_{v} )}{Pr ( {C}_{v} = 0 \vert {y}_{v} )}$$

where yᵥ is the channel output corresponding to the with codebit, Cᵥ.

The number of hidden layers in the trellis representation may be denoted by 2 L. Each of the hidden layers has a size E, i.e. E nodes where E is the number of edges in the Tanner graph which in turn corresponds to the number of ones in the parity check matrix. For each hidden layer, each processing element in that layer is associated with the message transmitted over some edge in the Tanner graph.

The output (last) layer of the trellis has a size N (which is the length of the code block), i.e. N nodes each comprising a processing element (total of N processing elements) that output the final decoded codeword, i.e. a recovered version of the code.

Each of the 2 L hidden layers of the trellis may be denoted as hidden layer (i) where i=1, 2, . . . , 2 L. For odd (even, respectively) values of i, each processing element in this layer outputs the message transmitted by the BP decoder over the corresponding edge in the Tanner graph from the associated Tanner graph variable (check) node to the associated Tanner graph check (variable) node. A processing element in the first hidden layer (i=1), corresponding to a respective edge e=(v, c) in the Tanner graph, is connected to a single input node in the input layer corresponding to a variable node v in the Tanner graph associated with the respective edge. Now referring to the hidden layer (i) where i>1, i.e. all hidden layers except for the first hidden layer. For odd (even, respectively) values of i, the processing element corresponding to a respective edge e=(v, c) in the Tanner graph is connected to all processing elements in layer i−1 associated with the edges e′=(v, c′) for c′ # c (edges e′=(v′, c) for v′ # v respectively). For odd i, a processing node in layer i, corresponding to the edge e=(v, c) in the Tanner graph, is also connected to the v^{th} input node.

The BP messages transmitted over the trellis graph are the following. For the hidden layer (i) (i=1, 2, . . . , 2 L), e=(v, c) may be the index of some processing element in that layer i. The output message of this processing element may be denoted by x_{i,e}. For odd (even, respectively) values of i, the message x_{i,e} is the message produced by the BP algorithm after [(i−1)/2] decoding iterations, from variable to check (check to variable) node.

For odd i and e=(v, c) the message x_{i,e} may be expressed by equation (1) below (it should be recalled that the self LLR message of v is lᵥ), under the initialization x_{0,e′}=0 for all edges e′ (in the beginning there is no information at the parity check nodes).

x_{i,e=(v,c)}=Iᵥ+Σ_{e′=(v,c′),c′≠c}x_{i-1,e′} Equation (1):

The summation in equation (1) is over all edges e′=(v, c′) with variable node v except for the target edge e=(v, c). It should be recalled that this is a fundamental property of message passing algorithms as known in the art.

Similarly, for even i and e=(v, c) the message x_{i,e} may be expressed by equation 2 below.

$${x}_{i , e = ( v , c )} = 2 {tanh}^{- 1} ( {\prod }_{{e}^{′} = ( {v}^{′} , c ) , {v}^{′} \neq v} tanh ( \frac{{x}_{i - 1 , {e}^{′}}}{2} ) ) \qquad Equation ( 2 )$$

The final v^{th} output of the trellis which is the final marginalization of the BP algorithm is expressed by equation (3) below.

oᵥ=Iᵥ+Σ_{e′=(v,c′)}x_{2L,e′} Equation (3):

According to some embodiments of the present invention, the deep neural network utilized by a decoder such as the decoder 210 executing the process 100 is a Feed-Forward (FF) neural network. The BP algorithm based decoder may be generalized by a parameterized deep neural network decoder 210 which may be an FF neural network employing a sum-product algorithm. The FF neural network decoder 210 may apply a trellis with hidden layers nodes corresponding to the edges in a bipartite graph (or bigraph), for example, a Tanner graph, a factor graph, and/or the like. In contrast to the BP decoder, in the FF neural network decoder 210, weights are assigned (associated) to the edges in the bipartite graph, for example, the Tanner graph of the encoded linear code. These weights are calculated and/or determined by training the neural network using one or more neural network training methods as known in the art, for example, stochastic gradient descent, batch gradient descent and mini-batch gradient descent and/or the like. This means the weights may be arbitrarily set for each of a plurality of corresponding edges in each layer of the FF neural network decoder 210 during each iteration of the training sequence.

More precisely, the sum-product neural network decoder 210 maintains the same trellis architecture as the trellis defined herein before for the BP decoder. However, for the sum-product neural network decoder 210, equations (1), (2) and (3) may be replaced with the following equation (4) for odd i, for even i equation (5) and equation (6) respectively to reflect the assigned weights.

x_{i,e=(v,c)}=tan h(½(w_{i,v}Iᵥ+Σ_{e′=(v,c′),c′≠c}w_{i,e,e′}x_{i-1,e′})) Equation (4):

x_{i,e=(v,c)}=2 tan h⁻¹(Π_{e′=(v′,c),c′≠v}x_{i-1,e′}) Equation (5):

oᵥ=σ(w_{2L+1,v}Iᵥ+Σ_{e′=(v,c′)}w_{2L+1,v,e′}x_{2L,e′}) Equation (6):

where σ(x)≡(1+e^{-x})⁻¹ is a sigmoid function. The sigmoid is added so that the final network output is in the range [0,1]. This may allow training the neural network using a cross entropy loss function, as described herein after.

Apart of the addition of the sigmoid function at the outputs of the network, it may be evident that by setting all weights to one, Equations (4)-(6) degenerate to equations (1)-(3) respectively. Hence by optimal setting (training) of the weights of the neural network decoder, its performance may not be inferior to plain BP decoder.

Evaluating the message passing decoding algorithm of the sum-product neural network decoder 210 as expressed in equations (4)-(6), it may be easily verified that the message passing decoding algorithm satisfies the message passing symmetry conditions. Hence, as known in the art, when transmitting the linear code over a Binary Memoryless Symmetric (BMS) channel, the error rate is independent of the transmitted codeword. Therefore, to train the neural network, it may be sufficient to use a dataset which is constructed using noisy versions (representing the noise induced during transmission over the transmission channel) of a single (training) codeword. For convenience the training codeword may be selected to be the zero codeword, which must belong to any linear code. The dataset may therefore reflect various channel output realizations when the zero codeword is transmitted. The goal is to train the weights {w_{i,v}, w_{i,e,e′}, w_{i,v,e′}} to achieve an N dimensional output which is a recovered version of the encoded codeword which is as close as possible to the zero codeword. The sum-product neural network architecture may be a non-fully connected neural network. The stochastic gradient descent method, the batch gradient descent and/or the mini-batch gradient descent may be used to train the neural network decoder 210 to calculate and/or determine the weights.

The advantage of the implementation of the parameterized neural network decoder 210 is that by setting the weights properly, small cycles in the Tanner graph representing the code may be compensated for. That is, messages sent by parity check nodes to variable nodes may be weighted, such that in case a message is less reliable since it is produced by a parity check node with a large number of small cycles in its local neighborhood, then this message will be attenuated properly.

The time complexity of the deep neural network algorithm is similar to the plain BP algorithm. Both algorithms have the same number of layers and the same number of non-zero weights in the Tanner graph. A deep neural network architecture is illustrated in FIG. 1 below for a Bose-Chaudhuri-Hocquenghem (BCH) code, in this example, a BCH(15,11) code.

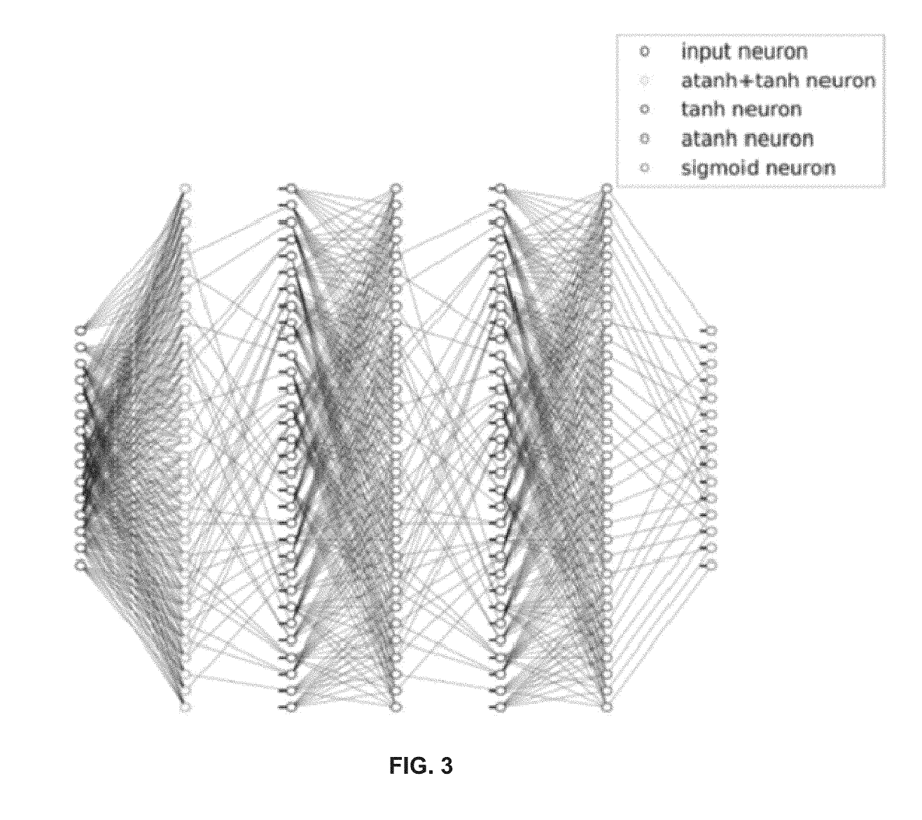

Reference is now made to FIG. 3, which is a schematic illustration of an exemplary FF deep neural network used for decoding an encoded linear block code, according to some embodiments of the present invention. FIG. 3 presents an exemplary FF deep neural network employed by a decoder such as the decoder 210 for decoding a BCH(15,11) encoded linear block code 220. The FF Deep Neural Network may include five hidden layers which correspond to three full BP iterations. It should be noted that the self LLR messages lᵥ are plotted as small bold lines. The first hidden layer and the second hidden layer that described herein above are merged together. It should also be noted that the exemplary FF deep neural network applies 3 full iterations and the final marginalization.

The FF neural network decoder 210 may be used to replace the BP decoder in one or more applications utilizing the BP decoder, for example, Random Redundant Iterative Decoding (RRD) algorithm, Multiple Bases Belief Propagation (MBBP) algorithm and/or the like as known in the art. In particular, the neural network decoder 210 may be used in a Modified RRD (mRRD) decoding algorithm which may be scaled to include multiple simultaneous decoding branches for decoding the linear block code(s) 220 corresponding to a parity check matrix such as, for example, the HDPC codes.

The mRRD algorithm based decoder may be a nearly optimal low complexity decoder for short length (N<100) algebraic linear codes such as, for example, BCH codes. This algorithm uses m parallel decoder branches, also referred to as permutation blocks, each comprising of c applications of several BP decoding iterations (e.g. two) followed by applying a set of permutation values obtained from the Automorphism Group of the code. The permutation values may be deterministic values selected from the Automorphism Group of the code. However, the permutation values may optionally be randomly selected from the Automorphism Group of the code. The decoding process in each decoder branch stops if the decoded (recovered) word is a valid codeword. The final decoded word (i.e. the recovered version 222) may be selected from an aggregation of the recovered versions of the codewords decoded by the plurality of decoder branches with a Least Metric Selector (LMS) as the recovered codeword for which the channel output has the highest likelihood.

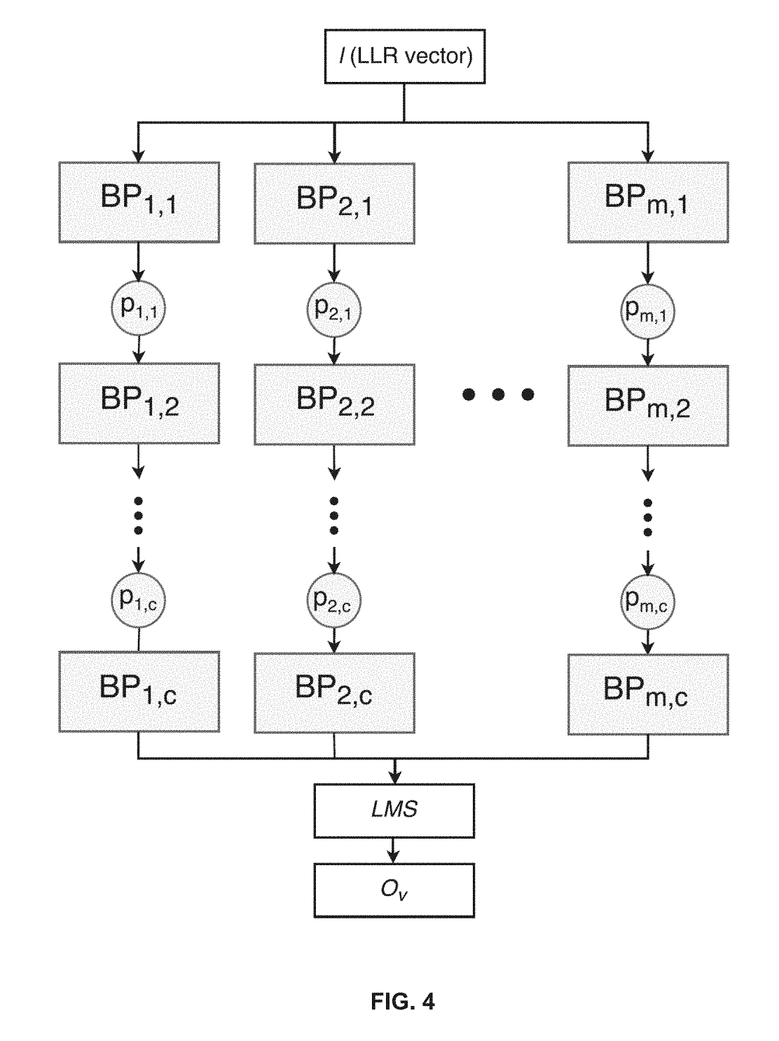

Reference is now made to FIG. 4, which is a schematic illustration of an exemplary modified Random Redundant Iterative Decoding (mRRD) decoder with m parallel decoders used for decoding an encoded linear block code, according to some embodiments of the present invention. FIG. 4 presents an exemplary multiple scaled mRRD implementation utilized by a decoder such as the decoder 210 having m parallel iterative decoders (decoding branches) with c BP blocks in each of the iterative decoders. The circles represent permutations selected from the Automorphism Group of the code.

Optionally, the weights assigned to the edges of the FF neural network decoder 210 are quantized using one or more techniques as known in the art for quantizing the weights of a neural network. Quantizing the weights may significantly reduce memory size and accesses, and may optionally allow replacing most arithmetic operations with bit-wise operations.

Performance of the FF neural network based decoder 210 was evaluated through a set of experiments conducted to test, evaluate and validate decoders such as the decoder 210 utilizing the FF neural network algorithm.

The tested neural network decoder 210 is built on top of the TensorFlow framework as known in the art. The neural network was trained using an NVIDIA Tesla K40c GPU for accelerated training. Cross entropy was applied as a loss function for the decoding training process as expressed in equation (7) below.

$$L ( o , y ) = - \frac{1}{N} {\sum }_{v = 1}^{N} {y}_{v} log ( {o}_{v} ) + ( 1 - {y}_{v} ) log ( 1 - {o}_{v} ) \qquad Equation ( 7 )$$

where oᵥ and yᵥ are the deep neural network output and the actual v^{th} component of the transmitted codeword.

In case the all zero codeword is transmitted then yᵥ=0 for all v. Training was conducted using stochastic gradient descent with mini-batches. The mini-batch size was 120 examples (samples). Root Mean Square Propagation (RMSPROP) rule was applied during the training with a learning rate equal to 0.001. The neural network has ten hidden layers, which correspond to five full iterations of the BP algorithm. Each processing element in an odd indexed hidden layer (i) is described by equation (4) and each processing element in an even indexed hidden layer (i) is described by equation (5).

At test time, noisy codewords after transmitting through an Additive White Gaussian Noise (AWGN) channel are injected and a BER is measured in the decoded (recovered) codeword at the neural network output. When computing equation (4), the input to the tan h function is clipped such that the absolute value of the input is always smaller than some positive constant A<10. This is also required for practical (finite block length) implementations of the BP algorithm in order to stabilize the operation of the decoder 210.

The neural network decoder 210 was trained on several different linear codes, including BCH(15,11), BCH(63,36), BCH(63,45) and BCH(127,106).

The feed-forward neural network architecture has the property that after every even hidden layer (i) a final marginalization may be added. This property may be used to add additional terms in the loss function. The additional terms may increase the gradient update at the backpropagation algorithm and allow learning the lower layers. At each even hidden layer (i) the final marginalization is added to the loss function thus constructing a multi-loss function as expressed in equation (8) below.

$$L ( o , y ) = - \frac{1}{N} {\sum }_{i = 2 , 4}^{2 L} {\sum }_{v = 1}^{N} {y}_{v} log ( {o}_{v , i} ) + ( 1 - {y}_{v} ) log ( 1 - {o}_{v , i} ) \qquad Equation ( 8 )$$

where o_{v,i}, yᵥ are the deep neural network outputs at even hidden layer (i) and the actual with component of the transmitted codeword. As exemplary such neural network architecture is illustrated in FIG. 3 below.

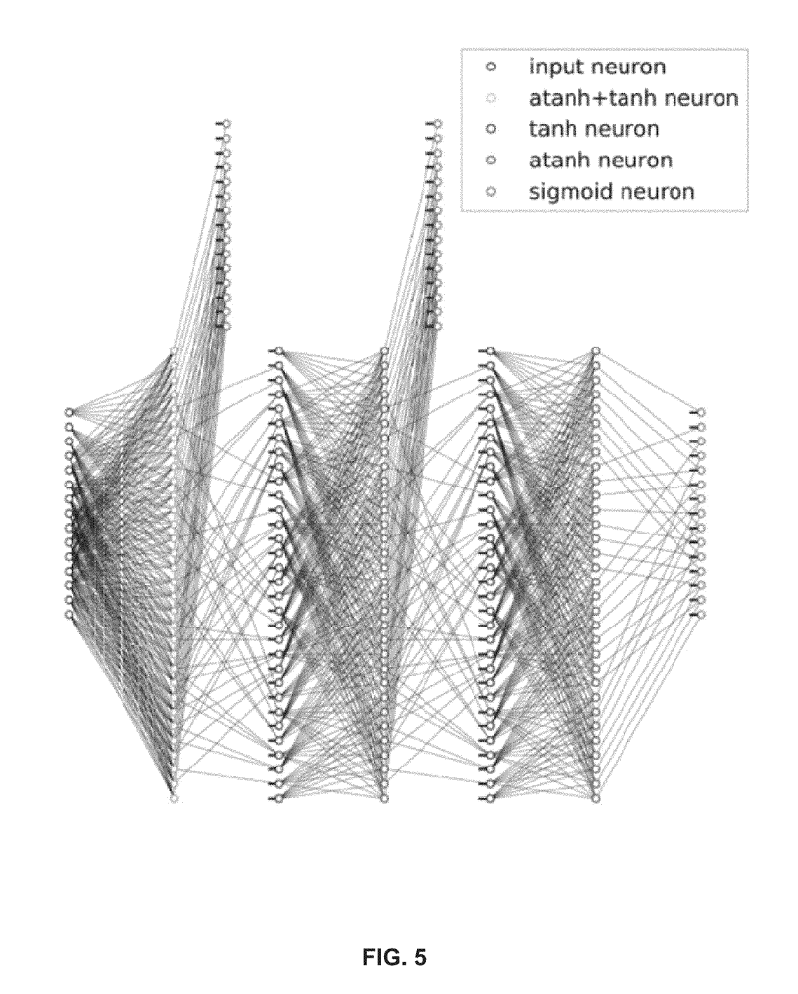

Reference is now made to FIG. 5, which is a schematic illustration of an exemplary FF deep neural network decoder applying multi-loss for decoding an encoded linear block code, according to some embodiments of the present invention. FIG. 5 presents an exemplary FF deep neural network utilized by a decoder such as the decoder 210 for decoding a BCH(15,11) linear block code 220, where the FF deep neural network is trained with a training multi-loss function. It should be noted that the self LLR messages lᵥ are plotted as small bold lines. The first hidden layer and the second hidden layer that were described herein above are merged together.

The training dataset may be created by transmitting the zero codeword through an AWGN channel with varying Signal to Noise Ratio (SNR) values ranging from 1 dB to 6 dB. For example, each mini-batch may include 20 codewords for each SNR value (a total of 120 examples in the mini batch). The test data may include codewords with the same SNR range as in the training dataset. The parity check matrices employed by the decoders may include a plurality of parity check matrices known in the art.

As demonstrated hereinafter in the experiments' results, for each of the tested BCH codes, the neural network decoder 210 presents improved performance compared to the BP decoder. It should be noted that for the BCH(15,11) code, the neural network algorithm based decoder 210 obtained close to maximum likelihood results. For larger BCH codes, both the BP algorithm decoder and the deep neural network decoder 210 may present a significant gap from the maximum likelihood results, however, in some use cases the neural network decoder 210 may present significant improvement over the BP decoder.

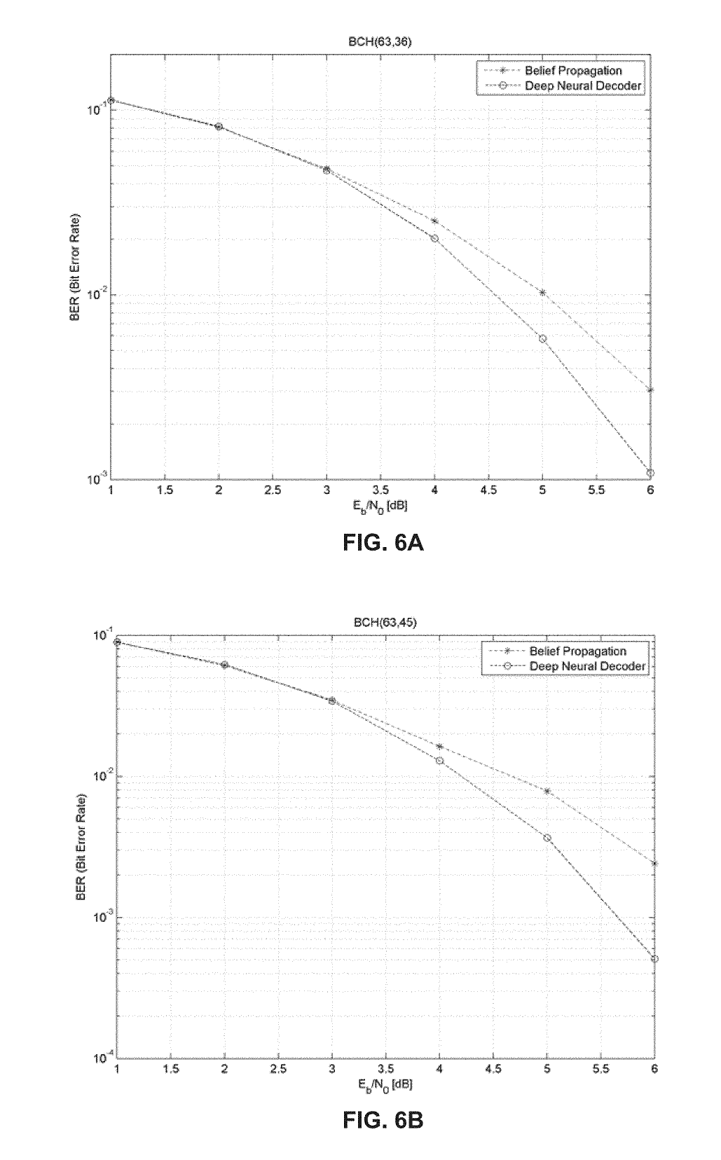

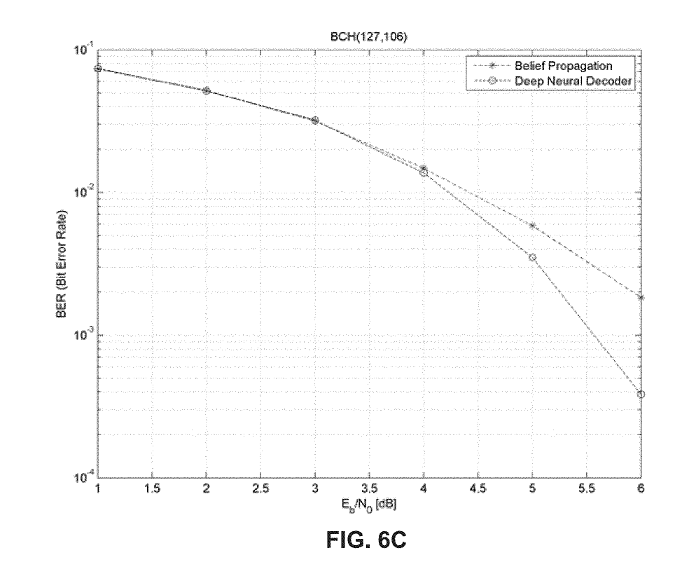

Reference is now made to FIG. 6A, FIG. 6B and FIG. 6C, which are graph charts of BER results for a neural network decoder decoding BCH(63,36), BCH(63,45) and BCH(127, 106) encoded linear block codes respectively, according to some embodiments of the present invention. As evident from FIG. 6A, FIG. 6B and FIG. 6C for BCH(63,36), BCH(63,45) and BCH(127,106) respectively, a neural network decoder such as the decoder 210 may presents an improvement of up to 0.75 dB in the high SNR region over the BP decoder. Furthermore, the BER presented by the deep neural network decoder 210 is consistently smaller or equal to the BER of the BP algorithm. This result is in agreement with the observation that the neural network decoder 210 may not perform worse than the BP decoder.

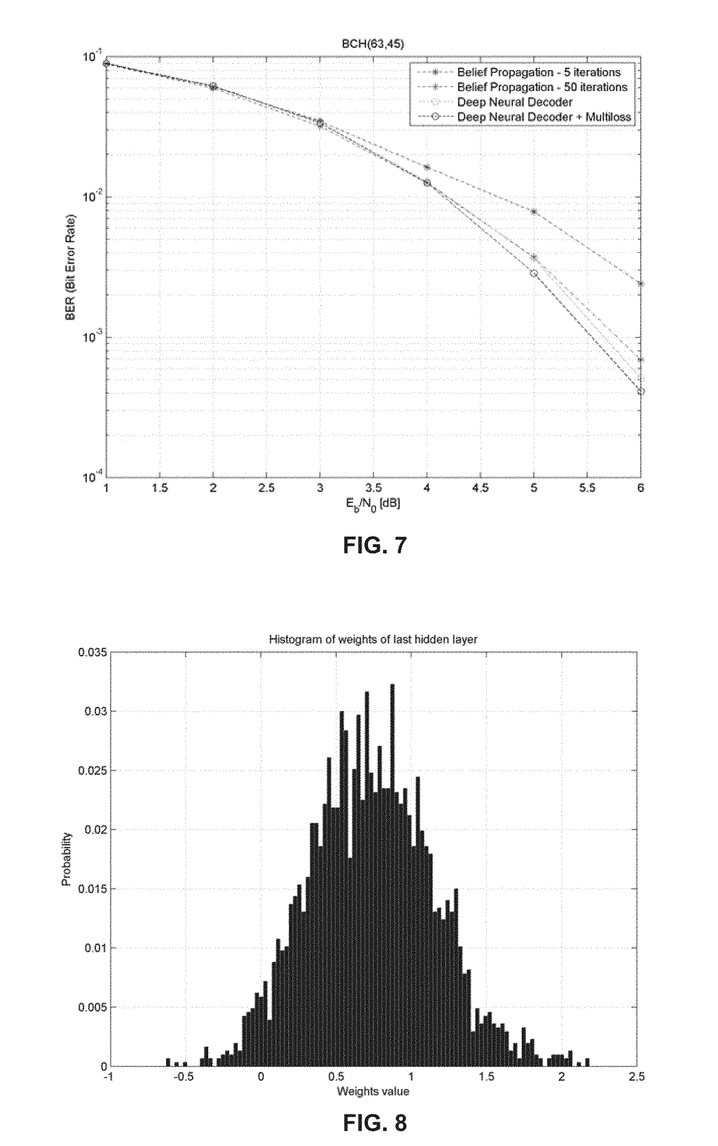

Reference is now made to FIG. 7, which is a graph chart of BER results for a neural network decoder applying multi-loss for decoding a BCH(63,45) encoded linear block code, according to some embodiments of the present invention. FIG. 7 presents the results of training a decoder such as the decoder 210 utilizing a deep neural network with the multi-loss function. The neural network decoder 210 shows an improvement of up to 0.9 dB compared to the plain BP algorithm decoder. Moreover, it may be observed that the same BER performance as achieved by a 50 iteration BP decoder may be achieved through five iterations of the deep neural network decoder 210. This equals a complexity reduction of the decoder 210 by a factor of 10.

The weights assigned to the edges of the BP decoder were compared to the weights of the FF neural network decoder 210 for a BCH(63,45) code. It may be observed that the deep neural network decoder 210 produces weights in the range from 0.8 to 2.2, in contrast to the BP decoder which has binary 1 or 0 weights.

Reference is now made to FIG. 8, which is a histogram chart of a distribution of weights assigned to a an output layer of a neural network decoder used for decoding a BCH(63,45) encoded linear block code, according to some embodiments of the present invention. FIG. 8 presents a weights histogram for the output (last) layer of a neural network decoder such as the decoder 210. Interestingly, the distribution of the weights is close to a normal distribution. In a similar way, every hidden layer in the trained deep neural network decoder 210 has a close to normal distribution. It should be noted that, as known in the art, the weights may be initialized with normal distribution.

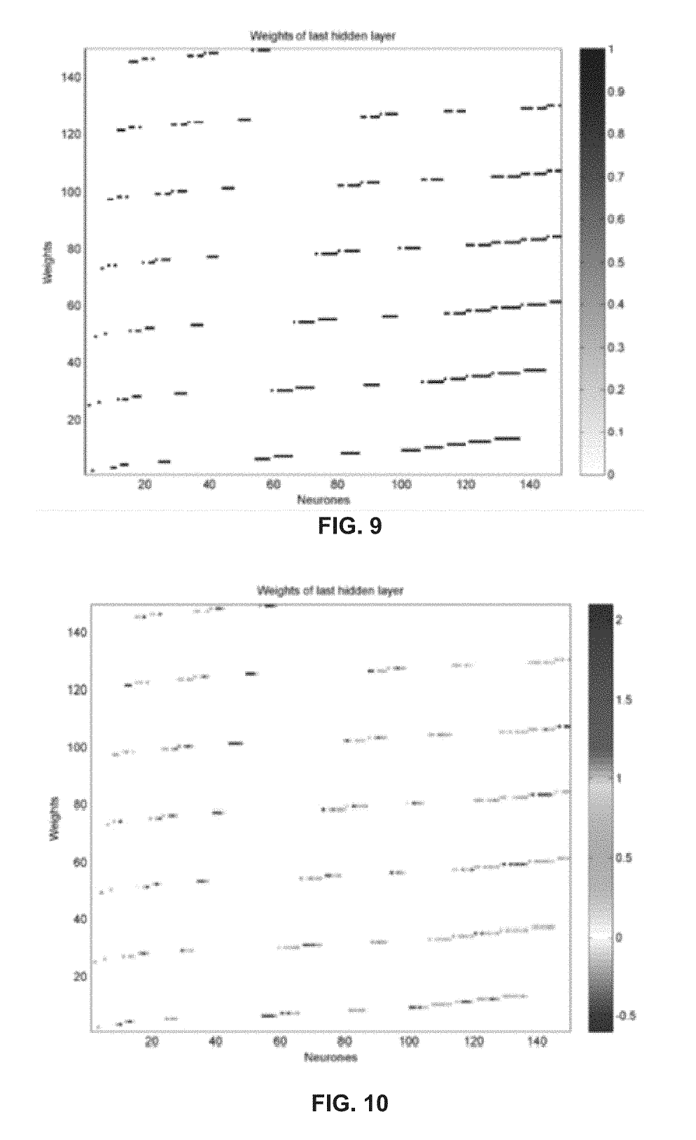

Reference is now made to FIG. 9 and FIG. 10, which are plots of weights assigned to a last hidden layer of a Belief Propagation (BP) decoder and a neural network decoder respectively used for decoding a BCH(63,45) encoded linear block code, according to some embodiments of the present invention. FIG. 9 and FIG. 10 present a plot the weights of the last hidden layer in a BP decoder and a neural network decoder such as the decoder 210 respectively. Each column in the figures corresponds to a neuron (processing element) described by Equation (4). It may be observed that most of the weights are zeros except the Tanner graph weights which have a value of 1 in FIG. 9 for the BP decoder and some real number in FIG. 10 for the neural network decoder 210. FIG. 9 and FIG. 10 presents only a quarter of the weights matrix for better illustration.

According to some embodiments of the present invention, the deep neural network utilized by a decoder such as the decoder 210 executing the process 100 is Recurrent Neural Network (RNN). The BP algorithm based decoder may be generalized by a parameterized deep neural network decoder 210 which may be an RNN based decoder. As described herein before for the FF neural network decoder 210, the RNN decoder 210 may apply the trellis having hidden layers nodes corresponding to the edges in the bipartite graph (or bigraph), for example, the Tanner graph, the factor graph, and/or the like. However, in contrast to the FF neural network algorithm, in the RNN algorithm the weights assigned (associated) to the edges in the bipartite graph, for example, the Tanner graph of the encoded linear code are tied. This means that equal weights are assigned to corresponding edges in each layer of the RNN decoder 210 during each iteration of the training sequence. Tying the weights between layers transforms the FF architecture as described herein before into the RNN architecture. Similarly to the FF neural network decoder 210, the RNN decoder 210 is trained to calculate and/or determine the weights using one or more neural network training methods as known in the art, for example, the stochastic gradient descent, the batch gradient descent, the mini-batch gradient descent and/or the like.

The processing elements x_{i,e} and the final marginalization oᵥ as expressed in equations (4), (5) and (6) for the FF neural network decoder 210 may accordingly be adjusted for the RNN decoder 210 for a time step t as expressed in equation (9), equation (10) and equation (11) below.

x_{t,e=(v,c)}=tan h(½(wᵥIᵥ+Σ_{e′=(c′,v),c′≠c}w_{e,e′}x_{t-1,e′})) Equation (9):

x_{t,e=(c,v)}=2 tan h⁻¹(Π_{e′=(v′,c),v′≠v}x_{t,e′}) for time step t, Equation (10):

o_{v,t}=σ(w′ᵥIᵥ+Σ_{e′=(c′,v)}w′_{v,e′}x_{t,e′}) Equation (11):

where σ(x)≡(1+e^{-x})⁻¹ is a sigmoid function.

The RNN algorithm may be initialized by setting x_{0,e}=0 for all e=(c, v). Similarly to the FF neural network architecture, the RNN architecture also preserves the message passing symmetry conditions. As result, the RNN decoder 210 may be trained using noisy versions of a single codeword. The training may be done as for the FF neural network decoder 210 with a cross entropy loss function at the last time step t as expressed in equation (12) below.

$$L ( o , y ) = - \frac{1}{N} {\sum }_{v = 1}^{N} {y}_{v} log ( {o}_{v} ) + ( 1 - {y}_{v} ) log ( 1 - {o}_{v} ) \qquad Equation ( 12 )$$

where Oᵥ and yᵥ are the final deep neural network output and the actual vth component of the transmitted codeword.

The RNN architecture has the property that after every time step t, a final marginalization may be added and the loss of these terms may be computed as known in the art. Again, as described for the of the FF neural network decoder 210, using multi-loss terms may increase the gradient update at the backpropagation through time algorithm and allow learning the earliest layers. At each time step t the final marginalization may be added to the loss as expressed in equation (13) below.

$$L ( o , y ) = - \frac{1}{N} {\sum }_{t = 1}^{T} {\sum }_{v = 1}^{N} {y}_{v} log ( {o}_{v , t} ) + ( 1 - {y}_{v} ) log ( 1 - {o}_{v , t} ) \qquad Equation ( 13 )$$

where o_{v,t}, yᵥ are the deep neural network outputs at the time step t and the actual vth component of the transmitted codeword.

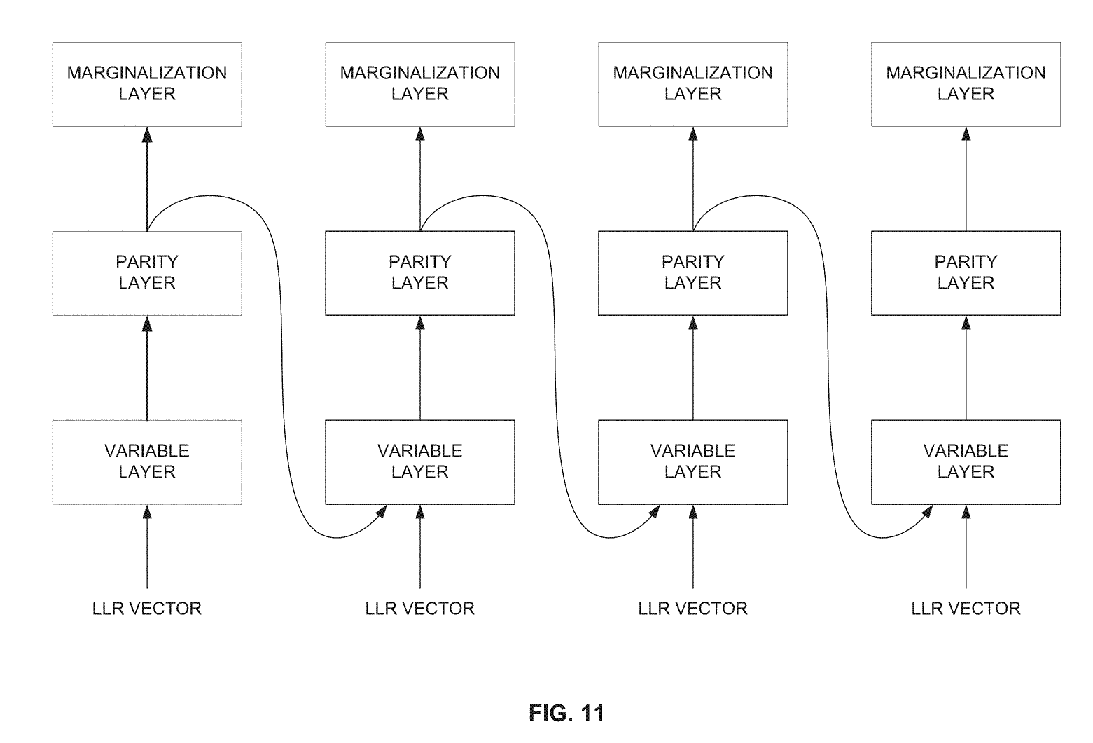

Reference is now made to FIG. 11, which is a schematic illustration of an exemplary RNN utilized by a decoder such as the decoder 210 for decoding an encoded linear block code, according to some embodiments of the present invention. An exemplary four fold RNN utilized by a decoder such as the decoder 210 may receive LLR vectors at its input layer. The nodes in the variable layer implement the processing element x_{t,e} as expressed in equation (9), while nodes in the parity layer implement the processing element x_{t,e} as expressed in equation (10). The nodes in the marginalization layer implement the final marginalization o_{v,t} as expressed in equation (11). The training goal is to minimize the loss function as expressed in equation (13).

As discussed for the FF neural network decoder 210 and illustrated in the exemplary implementation in FIG. 5, the RNN decoder 210 may also be used to replace the BP decoder in one or more applications utilizing the BP decoder. Such application may include, for example, the RRD algorithm, the MBBP algorithm and/or the like. In particular, the RNN decoder 210 may be applied to the mRRD decoding algorithm forming an mRRD-RNN decoder 210 which may be used to decode one or more linear block codes corresponding to parity check matrices such as, for example, the HDPC codes. The mRRD-RNN decoder 210 may achieve near maximum likelihood performance with less computational complexity compared to the BP decoder.

Optionally, the weights assigned to the edges of the RNN utilized by the decoder 210 are quantized using one or more techniques as known in the art for quantizing the weights of a neural network.

Performance of the RNN decoder 210 and the mRRD-RNN decoder 210 was evaluated through a set of experiments conducted to test, evaluate and validate decoders such as the decoder 210 utilizing the RNN and the mRRD-RNN algorithms. The RNN decoder 210 and the mRRD-RNN decoder 210 were applied to different linear block codes, for example, BCH(63,45), BCH(63,36), BCH(127,64) and BCH(127,99).

As presented herein after, in all experiments the results of training, validation and/or test sets are identical, with no observed overfitting. It should be noted that for the experiments session, the weight wᵥ used in equation (9) was not determined through training but rather set to 1, i.e. wᵥ=1.

Training was conducted using stochastic gradient descent with mini-batches. The training data is created by transmitting the zero codeword through an AWGN channel with varying SNR values ranging from 1 dB to 8 dB. The mini-batch size was 120, 80 and 40 examples to BCH codes with N=63, BCH(127,99) and BCH(127,64) respectively. The RMSPROP rule was applied during the training with a learning rate equal to 0.001, 0.0003 and 0.003 to BCH codes with N=63 (e.g. BCH(63,36) and BCH(63,45)), BCH(127,99) and BCH(127,64) respectively. The tested RNN decoder 210 has two hidden layers at each time step t, and unfold equal to five which corresponds to five full iterations of the BP algorithm. At test time, noisy codewords after transmitted through an Additive White Gaussian Noise (AWGN) channel are injected and a BER is measured in the decoded (recovered) codeword at the neural network output. The input to the tan h function of equation (9) is clipped such that the absolute value of the input is always smaller than some positive constant A<10. This is also required for practical (finite block length) implementations of the BP algorithm in order to stabilize the operation of the decoder 210.

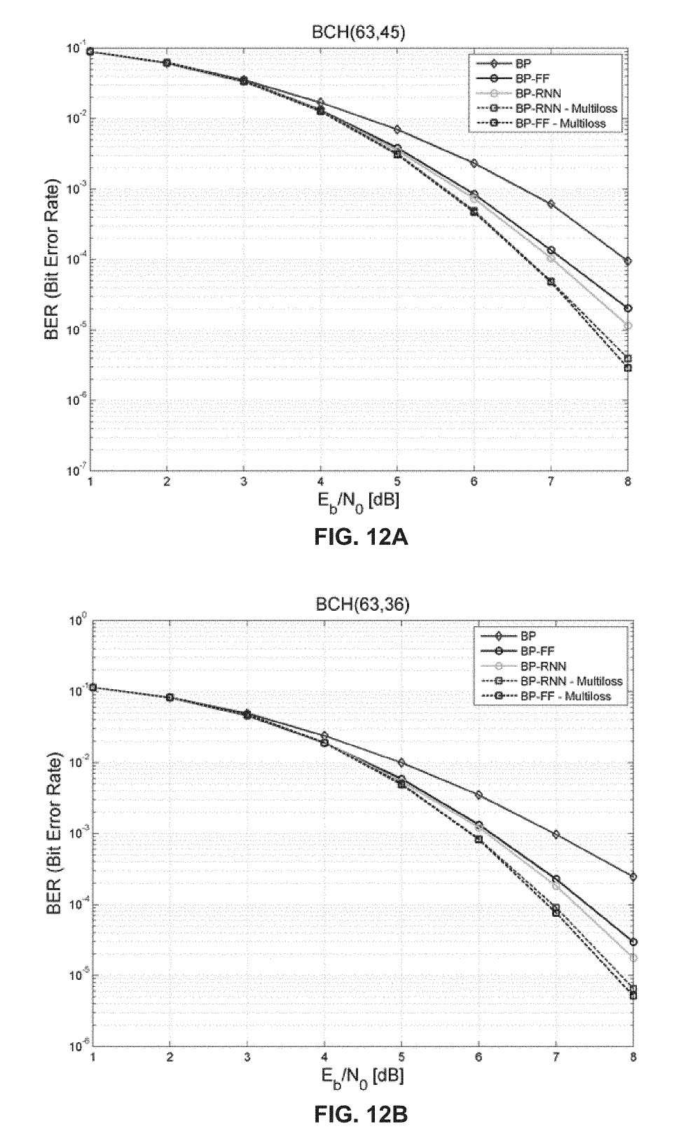

Reference is now made to FIG. 12A and FIG. 12B, which are graph charts of BER results for neural network decoders such as the decoder 210 using regular parity check for decoding BCH(63,45) and BCH(63,36) encoded linear block codes 220 respectively, according to some embodiments of the present invention. FIG. 12A and FIG. 12B present the BER for decoding BCH(63,45) and BCH(63,36) encoded linear block codes respectively using regular parity check matrix as known in the art. As can be seen from the charts in FIG. 12A and FIG. 12B, the RNN (BP-RNN) decoder 210 outperforms the FF neural network (BP-FF) decoder 210 by 0.2 dB. Not only that the BER is improved, the RNN decoder 210 may have less free weights. Moreover, it may be seen that the RNN decoder 210 obtains comparable results to the BP-FF decoder 210 when training with the multi-loss function. Furthermore, for BCH(63,45) and BCH(63,36) the RNN decoder 210 presents an improvement of up to 1.3 dB and 1.5 dB, respectively over the plain BP decoder.

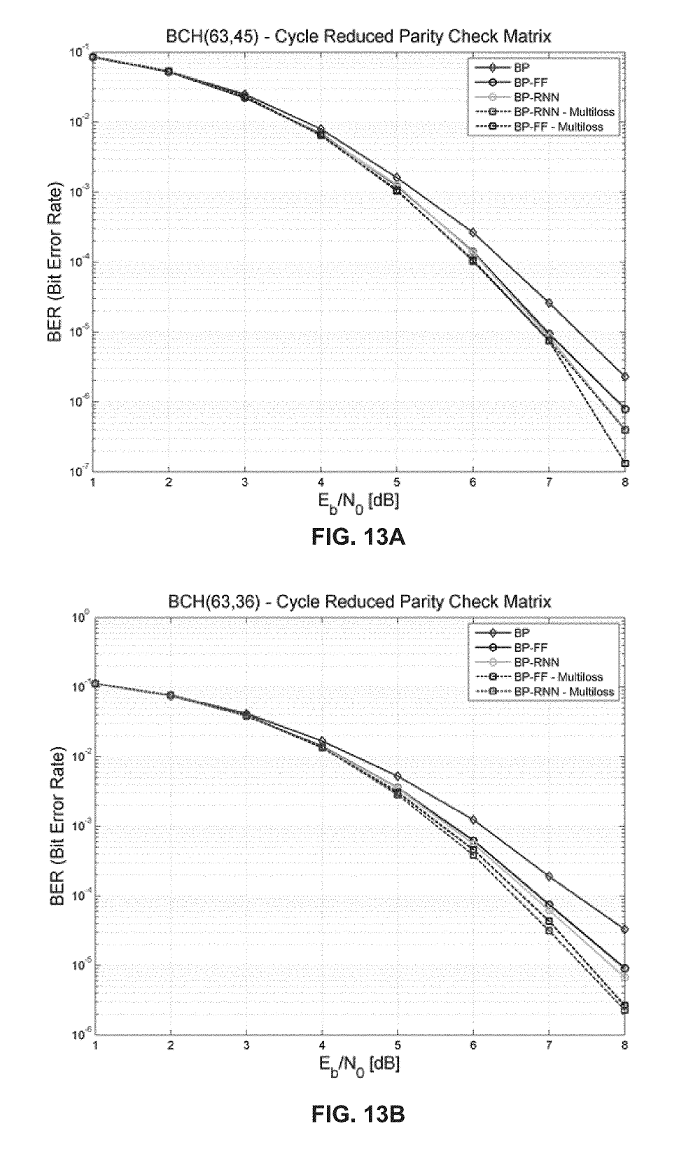

Reference is also made to FIG. 13A and FIG. 13B, are graph charts of BER results for neural network decoders such as the decoder 210 using reduced parity check for decoding BCH(63,45) and BCH(63,36) encoded linear block codes respectively, according to some embodiments of the present invention. FIG. 12A and FIG. 12B present the BER for decoding BCH(63,45) and BCH(63,36) encoded linear block codes 220 respectively using a cycle reduced parity check matrix as known in the art. As may be observed, for BCH(63,45) and BCH(63,36) the BP-RNN decoder 210 presents an improvement of up to 0.6 dB and 1.0 dB respectively. This observation may demonstrate that the BP-RNN decoder 210 utilizing the soft Tanner graph is capable of improving the performance over the standard BP decoder even for reduced cycle parity check matrices.

This performance improvement may resolve the uncertainty regarding the performance of the neural decoder 210, either the BP-FF decoder 210 and/or the BP-RNN 210 decoder on a cycle reduced parity check matrix and confirm the BP-FF and/or the BP-RNN decoders 210 may properly and potentially superiorly decode linear codes corresponding to cycle reduced parity check matrix. The importance of this resolution is that further improvement may be achieved in the decoding performance, as BP, both the standard BP and the new parameterized BP algorithms (i.e. the BP-FF and/or the BP-RNN), yields a lower error rate for sparser parity check matrices.

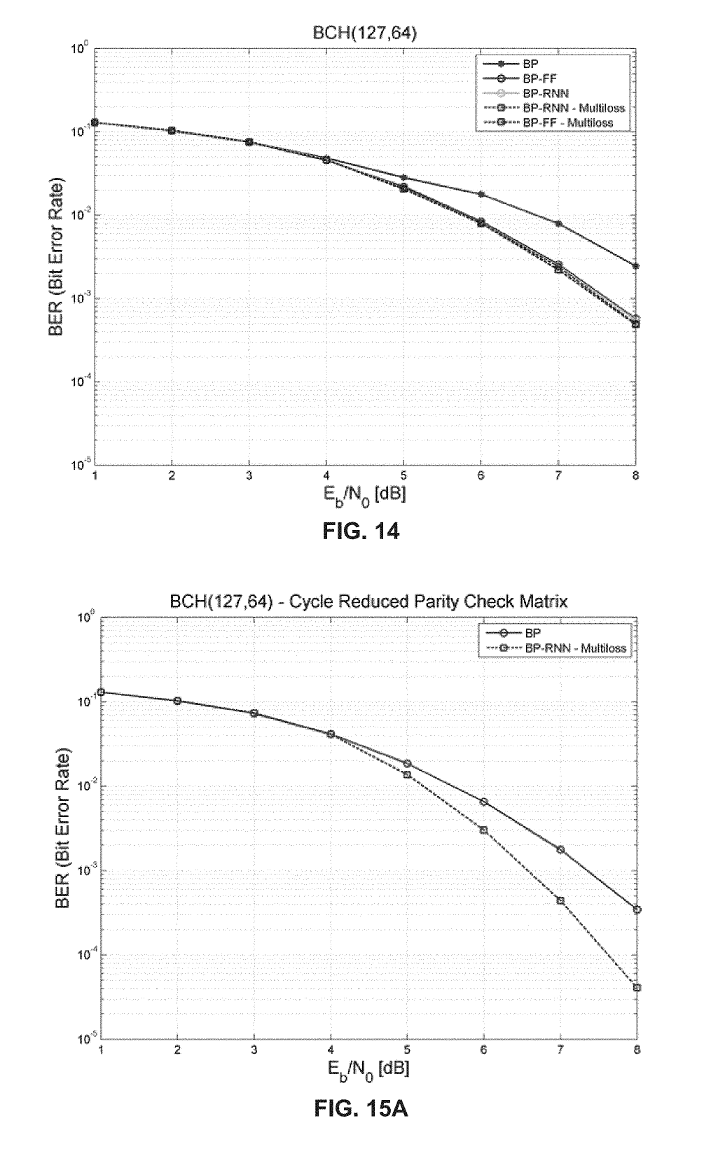

Reference is now made to FIG. 14, which is a graph chart of BER results for a neural network decoder such as the decoder 210 applying regular parity check for decoding a BCH(127,64) encoded linear block code, according to some embodiments of the present invention. The chart graph in FIG. 14 presents the BER for decoding a BCH(127,64) encoded linear block code using regular parity check matrix as known in the art. As can be seen from the graph chart, for a regular parity check matrix, the BP-RNN decoder 210 and the BP-FF decoder 210 present improvement of up to 1.0 dB over the BP decoder, however, the BP-RNN decoder 210 may use less free weights than the BP-FF decoder 210.

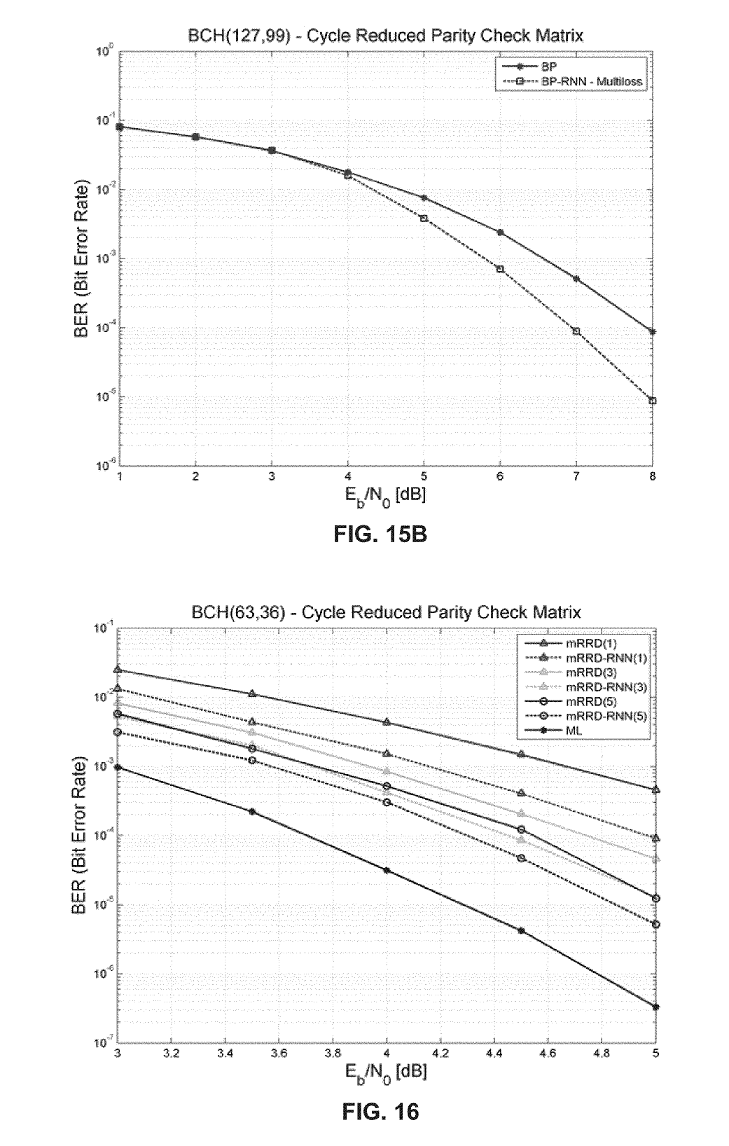

Reference is now made to FIG. 15A and FIG. 15B, which are graph charts of BER results for a neural network decoder such as the decoder 210 applying regular parity check for decoding a BCH(127,64) and BCH(127,99) encoded linear block codes respectively, according to some embodiments. As can be seen from the graph chart in FIG. 15A for BCH(127,64) and from the graph chart in FIG. 15B for BCH(127,99), the BP-RNN decoder 210 presents improvement of up to 0.9 dB and 1.0 dB respectively compared to the BP decoder.

Reference is now made to FIG. 16, which is a graph chart of BER results for mRRD and mRRD-RNN decoders such as the decoder 210 decoding a BCH(63,36) encoded linear block code, according to some embodiments of the present invention. The chart graph in FIG. 16 presents the BER for decoding a BCH(63,36) encoded linear block code corresponding to a reduced parity check matrix as known in the art. In all experiments the soft Tanner graph is used after trained using the BP-RNN decoder architecture optimized with the multi-loss function and having an unfold of five which corresponds to five iterations of the BP algorithm.

The parameters of the mRRD-RNN decoder 210 are as follows. Two iterations are used for each BP_{i,j} block of the mRRD as presented in FIG. 4, a value of m=1,3,5 (number of parallel decoders) denoted in the following by mRRD-RNN(m), and a value of c=30. The graph chart presents the BER for mRRD-RNN(1), mRRD-RNN(3) and mRRD-RNN(5).

As can be seen, the mRRD-RNN(1) decoder 210, the mRRD-RNN(3) decoder 210 and the mRRD-RNN(5) decoder 210 present improvements of 0.6 dB, 0.3 dB and 0.2 dB respectively compared to corresponding mRRD decoders utilizing the BP algorithm. Hence, the mRRD-RNN decoder 210 may improve on the plain mRRD decoder. Also it should be noted that the mRRD-RNN decoder 210 presents a performance gap of only 0.6 dB from the optimal maximum likelihood decoder as estimated based on implementations, models and/or algorithms as known in the art.

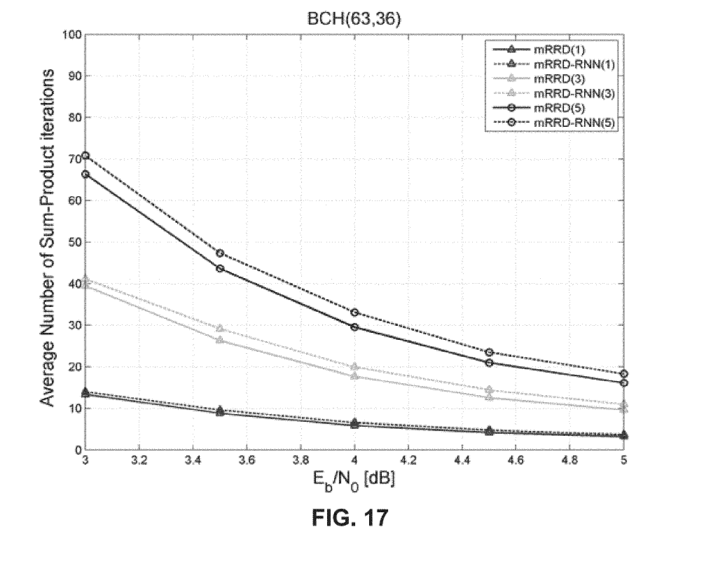

Reference is now made to FIG. 17, which a graph chart of average number of BP iterations for mRRD and mRRD-RNN decoders such as the decoder 210 decoding a BCH(63,36) encoded linear block code, according to some embodiments of the present invention. The graph chart presents a comparison of an average number of BP iterations for the various decoders using the plain mRRD (utilizing the BP algorithm) and the mRRD-RNN algorithm. As evident from the graph chart, there is a small increase in the complexity of up to 8% when using the mRRD-RNN decoder 210. However, overall, the mRRD-RNN decoder 210 may achieve the same error rate as the plain mRRD with a significantly smaller computational complexity due to the reduction in the required value of m.

To conclude, the RNN architecture used by the decoder 210 for decoding linear block codes may yield comparable results to FF neural network decoder 210 with less free weights. Furthermore, as demonstrated, the neural network decoder 210 (the BP-FF and/or the BP-RNN decoders 210) may improve on the standard BP even for cycle reduced parity check matrices, with improvements of up to 1.0 dB in the SNR.

Also, the performance improvement is demonstrated for the mRRD algorithm using the RNN architecture.

It is expected that during the life of a patent maturing from this application many relevant systems, methods and computer programs will be developed and the scope of the terms linear block codes and neural networks are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A computer implemented method of decoding a linear block code transmitted over a transmission channel subject to noise, comprising:
using at least one processor for:
receiving, over a transmission channel, a linear block code corresponding to a parity check matrix;
propagating the received code through a neural network of at least one decoder, the neural network having an input layer, an output layer and a plurality of hidden layers comprising a plurality of nodes corresponding to transmitted messages over a plurality of edges of a bipartite graph representation of the encoded code and a plurality of edges connecting the plurality of nodes, wherein each one of the plurality of edges having a source node and a destination node is assigned with a weight previously calculated during a training session of the neural network, the propagation follows a propagation path through the neural network dictated by respective weights of the plurality of edges; and
outputting a recovered version of the code according to a final output of the neural network.

2. The computer implemented method of claim 1, wherein the bipartite graph is a member of a group consisting of: a Tanner graph and a factor graph.

3. The computer implemented method of claim 1, wherein the parity check matrix is a member of a group consisting of: algebraic linear code, polar code, Low Density Parity Check (LDPC) code and High Density Parity Check (HDPC) code.

4. The computer implemented method of claim 1, wherein the training session is conducted through a plurality of training iterations using a dataset comprising a plurality of samples, each of the plurality of samples maps at least one training codeword of the code that is subjected to a different noise pattern injected to the transmission channel.

5. The computer implemented method of claim 4, wherein the at least one training codeword is the zero codeword.

6. The computer implemented method of claim 4, wherein the training is done using at least one of: stochastic gradient descent, batch gradient descent and mini-batch gradient descent.

7. The computer implemented method of claim 4, wherein during the training, an updated marginalization value is calculated for each even layer of the plurality of hidden layers, a multi-loss function used for the training is updated with the updated marginalization value.

8. The computer implemented method of claim 1, wherein the neural network is a feed-forward neural network in which the weight is arbitrarily set for each of a plurality of corresponding edges in each layer of the neural network.

9. The computer implemented method of claim 1, wherein the neural network is a recurrent neural network (RNN) in which the weight is equal for corresponding edges in each layer of the neural network.

10. The computer implemented method of claim 1, further comprising the weight is quantized.

11. The computer implemented method of claim 1, further comprising generating an aggregated recovered version of the code by aggregating the recovered version produced by a plurality of decoders such as the at least one decoder.

12. The computer implemented method of claim 11, wherein the weight is calculated for each one of the plurality of decoders by training a respective neural network of the each decoder using a different set of permutation values of the code following each of a plurality of training iterations, wherein the set of permutation values is deterministically set and/or randomly selected from an automorphism group of the code.

13. A system for decoding a linear block code transmitted over a transmission channel subject to noise, comprising:
at least one processor adapted to execute code, the code comprising:
code instructions to receive, over a transmission channel, a linear block code corresponding to a parity check matrix;
code instructions to propagate the received code through a neural network of at least one decoder, the neural network having an input layer, an output layer and a plurality of hidden layers comprising a plurality of nodes corresponding to transmitted messages over a plurality of edges of a bipartite graph representation of the encoded code and a plurality of edges connecting the plurality of nodes, wherein each one of the plurality of edges having a source node and a destination node is assigned with a weight previously calculated during a training session of the neural network, the propagation follows a propagation path through the neural network dictated by respective weights of the plurality of edges; and
code instructions to output a recovered version of the code according to a final output of the neural network.

14. The system of claim 13, wherein the bipartite graph is a member of a group consisting of: a Tanner graph and a factor graph.

15. The system of claim 13, wherein the parity check matrix is a member of a group consisting of: algebraic linear code, polar code, Low Density Parity Check (LDPC) code and High Density Parity Check (HDPC) code.

16. The system of claim 13, wherein the training session is conducted through a plurality of training iterations using a dataset comprising a plurality of samples, each of the plurality of samples maps at least one training codeword of the code that is subjected to a different noise pattern injected to the transmission channel.

17. The system of claim 16, wherein the at least one training codeword is the zero codeword.

18. The system of claim 16, wherein the training is done using at least one of:
stochastic gradient descent, batch gradient descent and mini-batch gradient descent.

19. The system of claim 16, wherein during the training, an updated marginalization value is calculated for each even layer of the plurality of hidden layers, a multi-loss function used for the training is updated with the updated marginalization value.

20. The system of claim 16, further comprising the weight is quantized.
